(19) United States
(12) Patent Application Publication
(10) Pub. No.: US 2025/0292984 A1
(43) Pub. Date: Sep. 18, 2025

(54) CURRENT LIMITING FUSE ASSEMBLY, TRANSFORMER ASSEMBLY COMPRISING A CURRENT LIMITING FUSE ASSEMBLY, AND SHIELDING ARRANGEMENT CONFIGURED TO ELECTRICALLY AND MECHANICALLY SHIELD A CURRENT LIMITING FUSE

(71) Applicant: Hitachi Energy Ltd, Zürich (CH)

(72) Inventors: Sergio SCHLICKMAM, Blumenau (BR); Andre DE SOUZA MELO, Guarulhos (BR)

(21) Appl. No.: 18/934,837

(22) Filed: Nov. 1, 2024

(30) Foreign Application Priority Data
Mar. 14, 2024 (EP) 24163410.4

(51) Int. Cl. H01H 85/165; H01F 27/02; H01F 27/40; H01H 85/02

(52) U.S. Cl. CPC H01H 85/165; H01F 27/402; H01H 85/0241; H01F 27/02; H01F 2027/404; H01H 2085/0291

(57) ABSTRACT

A current limiting fuse assembly includes a current limiting fuse having a longitudinal axis, and a shielding arrangement configured to electrically and mechanically shield the current limiting fuse. The shielding arrangement includes a first part and a second part. The first part includes a cylindrical portion extending along a first axis between a first end and a second end, and a flange portion provided at the second end. The second part includes a cylindrical portion extending along a second axis between a first end and a second end, and a flange portion provided at the second end. The second part is positioned and oriented relative to the first part such that the second end of the second part faces the second end of the first part. The second end of the second part is arranged at a distance from the second end of the first part.

### CROSS REFERENCE TO RELATED APPLICATIONS

The present application claims benefit of priority to European Patent Application No. 24163410.4, filed Mar. 14, 2024, and is assigned to the same assignee as the present application and is incorporated herein by reference in its entirety.

### BACKGROUND

The present disclosure relates to a current limiting fuse assembly. The present disclosure further relates to a transformer assembly which comprises a current limiting fuse assembly and to a shielding arrangement, configured to electrically and mechanically shield a current limiting fuse.

A transformer is a passive electrical device that transfers electrical energy from one electrical circuit to another, or to multiple circuits. The transformer typically comprises a ferromagnetic core having vertical limbs extending between a bottom yoke and a top yoke. Coils are wound around the limbs. A varying current in any one of the coils produces a varying magnetic flux in the core, which induces a varying electromotive force across any other coil wound around the core.

A so-called pad-mounted transformer is a ground-mounted utility distribution transformer, which usually is housed in a locked metal cabinet, situated on a small concrete pad. Pad-mounted transformers are generally connected to underground utility distribution lines at what is called a “service drop”, in order to step down the primary voltage on the utility distribution line to the lower secondary voltage which is then supplied to a utility customer. A typical enclosure includes a tank for holding the core and the coil assembly of the transformer immersed in oil or another dielectric liquid, and a wiring cabinet having high and low voltage wiring compartments for enclosing the high and low voltage bushings, respectively, of the transformer, etc. In order to prevent unauthorized access to the core and the coil assembly a cover is typically welded over the top of the tank.

Pad-mounted transformers are usually manufactured in power ratings from around 100 kVA to around 10,000 kVA and typically include built-in fuses and switches. Specifically, it is known to use current limiting fuses for protecting the transformer. Current limiting fuses may be arranged in a transformer tank-immersed in the oil as the core and the coils-above the primary or high voltage side of the transformer, specifically above the active part of the transformer which includes the core and the windings of the coils. The fuses are thus arranged in a confined or limited space.

A partial discharge is a localized electrical discharge that only partially bridges the insulation between conductors and which can or cannot occur adjacent to a conductor. Partial discharge is evidence of a degrading insulation system, which could lead to very costly repairs and can predictively lead to an electrical breakdown of high voltage apparatus. The phenomenon is of great practical interest in the electric power industry, as the presence and magnitude of partial discharge are important criteria to measure for the early detection of degrading insulation quality and the assessment of manufactured, installed, or repaired product quality.

It is known to conduct partial discharge tests with transformers to accomplish standards such as standards according to the Institute of Electrical and Electronics Engineers (IEEE) or the International Electrotechnical Commission (IEC). Conducting a partial discharge test generally requires subjecting the device to be tested to a particular high degree of voltage.

Current-limiting fuses are made of conductive segments with different formats containing sharp edges and fillers for electrical insulation. When a partial discharge test is conducted with a transformer including current-limiting fuses, the current-limiting fuses—due to the high voltage—may interfere in an undesirable way with the partial discharge test. Moreover, there is a non-negligible risk that current-limiting fuses explode during operation, resulting in particles dropping over the core and the windings of the transformer, and contaminating insulation elements of the transformer. Such a contamination of the active part usually leads to functional risks and significant repair costs. Typically, this requires the active part to be replaced.

Therefore, partial discharge tests with transformers are currently conducted in a state of the transformer in which the current limiting fuses are not installed. However, this leads to considerable additional work in the manufacture of the transformer because the manufacturing process has to be interrupted by the test. Moreover, updates of IEEE and IEC standards now specify a partial discharge test to be conducted with a transformer in a completely assembled state.

Therefore, there is a need for a transformer assembly that is particularly suitable for partial discharge tests and for a corresponding current-limiting fuse assembly.

### SUMMARY

According to the present disclosure a current limiting fuse assembly is provided which comprises a current limiting fuse having a longitudinal axis, and a shielding arrangement configured to electrically and mechanically shield the current limiting fuse. The shielding arrangement comprises a first part and a second part. The first part comprises a cylindrical portion extending along a first axis between a first end and a second end, and a flange portion provided at the second end. The second part comprises a cylindrical portion extending along a second axis between a first end and a second end, and a flange portion provided at the second end. The second part is positioned and oriented relative to the first part such that the second end of the second part faces the second end of the first part. The second end of the second part is arranged at a distance, measured along the longitudinal axis, from the second end of the first part.

The shielding arrangement allows providing electrical shielding of the current limiting fuse that is so effective that it prevents undesirable effects or interferences on a partial discharge test conducted with a transformer assembly when the current limiting fuse is part of the transformer assembly. Additionally, the shielding arrangement also allows providing mechanical protection of the transformer assembly in the event of an explosion of the current limiting fuse.

By providing the distance between the first part and the second part, it is possible to prevent a short circuit from occurring. In other words, the risk of sparking can be reduced or even eliminated for a certain voltage applied to the current limiting fuse. Accordingly, it is preferred if only an electrically non-conductive material is provided between the two parts. The dimension of the distance is preferably selected depending on the intended voltage. By providing the two flange portions, it is possible to ensure that no sharp edges are formed at the two second ends of the two parts that point towards each other. This may again be advantageous in electrical respects. In this sense, it may be particularly advantageous if the flange portion of the first part as such forms the second end of the first part. The same holds for the second part. The cylindrical portions of the two parts provide suitable shielding of the current limiting fuse with a particularly space-saving design.

Various embodiments may implement one or more of the following features:

The distance may be is at least 20 mm, preferably at least 25 mm, preferably at least 30 mm, preferably at least 50 mm. These are suitable corresponding minimum values, for example in case of a current fuse having a range between 30 A to 200 A, for example in case of a current fuse having a fuse class between 8 kV and 40 kV. These are typical values, for example, in case of a pad-mounted transformer.

The distance may be at maximum 120 mm, preferably at maximum 100 mm, preferably at maximum 80 mm, preferably at maximum 60 mm, preferably at maximum 50 mm, preferably at maximum 40 mm, preferably at maximum 35 mm. Again, these are corresponding suitable maximum values.

The distance may be between 20 mm and 120 mm, preferably between 20 mm and 100 mm, preferably between 25 mm and 80 mm, preferably between 25 mm and 60 mm, preferably between 30 mm and 50 mm, preferably between 30 mm and 40 mm, preferably between 30 mm and 35 mm, for example 33 mm.

The length of the second part measured along the second axis may be the same as the length of the first part measured along the first axis. This is an advantageous way of achieving symmetrical shielding of the current limiting fuse in relation to the longitudinal axis of the fuse. The first part and the second part may be arranged symmetrically to each other.

The length of the second part measured along the second axis may differ less than 50% from the length of the first part measured along the first axis, preferably less than 40%, preferably less than 30%, preferably less than 20%, preferably less than 10%.

The second part may geometrically at least generally correspond to or may be identical in construction to the first part. This may be particularly advantageous in terms of manufacture of the shielding arrangement and symmetry of the shielding effect.

The current limiting fuse may partly extend in the cylindrical portion of the first part and partly extend in the cylindrical portion of the second part.

The shielding arrangement may cover the current limiting fuse over at least 50% of its extent along the longitudinal axis, preferably over at least 60%, preferably over at least 70%, preferably over at least 80%.

The first part may have a length measured along the first axis of between 150 mm and 400 mm, preferably between 200 mm and 300 mm, preferably between 240 mm and 300 mm. The second part may have a length measured along the second axis of between 150 mm and 400 mm, preferably between 200 mm and 300 mm, preferably between 240 mm and 300 mm.

The first part may surround a first section of the current limiting fuse. The second part may surround a second section of the current limiting fuse.

The length of the second section of the current limiting fuse may be the same as the length of the first section of the current limiting fuse.

The length of the second section of the current limiting fuse measured along the longitudinal axis may differ less than 50% from the length of the first section of the current limiting fuse measured along the longitudinal axis, preferably less than 40%, preferably less than 30%, preferably less than 20%, preferably less than 10%.

The first axis may coincide with the second axis.

The longitudinal axis of the current limiting fuse may coincide with at least one of the first axis and the second axis. The longitudinal axis of the current limiting fuse may coincide with both the first axis and the second axis.

The first axis and the second axis may be coaxial. The first axis and/or the second axis may be coaxial with the longitudinal axis.

The cylindrical portion of the first part and/or the cylindrical portion of the second part may have a circular cross-section. This enables a particularly space-saving design, in particular if the current limiting fuse has an essentially circular cylindrical surface.

The cylindrical portion of the first part and/or the cylindrical portion of the second part may have a circular or a non-circular cross-section, for example an oval cross-section, a rectangular cross-section or a polygonal cross-section, for example a hexagonal cross-section.

Viewed in a cross-section normal to the longitudinal axis of the current limiting fuse, an annular gap may be formed between the current limiting fuse and the first part and/or between the current limiting fuse and the second part. The annular gap allows providing improved protection, especially in the event of an explosion of the current limiting fuse. The annular gap may be at least 2 mm wide, preferably at least 5 mm. The annular gap may be smaller than 20 mm, preferably smaller than 10 mm.

The following features of the flange portions are particularly advantageous with regard to the electrical properties of the current limiting fuse assembly, in particular with regard to the prevention of sparking.

The flange portion of the first part and/or the flange portion of the second part may have a closed ring shape.

The flange portion of the first part may show an outer diameter which is at least 5% larger than an outer diameter of the cylindrical portion of the first part, preferably at least 10%, preferably at least 15%. The flange portion of the second part may show an outer diameter which is at least 5% larger than an outer diameter of the cylindrical portion of the second part, preferably at least 10%, preferably at least 15%.

The outer diameter of the flange portion of the first part may be at maximum 50% larger than the outer diameter of the cylindrical portion of the first part, preferably at maximum 40% larger, preferably at maximum 30% larger. The outer diameter of the flange portion of the second part may be at maximum 50% larger than the outer diameter of the cylindrical portion of the second part, preferably at maximum 40% larger, preferably at maximum 30% larger.

The outer diameter of the flange portion of the first part may be between 1.05 times and 1.5 times the outer diameter of the cylindrical portion of the first part, preferably between 1.1 times and 1.4 times, preferably between 1.15 times and 1.3 times. The outer diameter of the flange portion of the second part may be between 1.05 times and 1.5 times the outer diameter of the cylindrical portion of the second part, preferably between 1.1 times and 1.4 times, preferably between 1.15 times and 1.3 times.

The extension of the flange portion of the first part measured along the first axis may be less than 20% of the length of the first part measured along the first axis, preferably less than 10%, preferably less than 7%. The same applies analogously for the extension of the flange portion of the second part.

The first part may be structured in such a way that the second end of the first part is without any sharp edges. Specifically, the second end of the first part may be without any edges having a radius of curvature of less than 5 mm, preferably less than 4 mm, preferably less than 3 mm, preferably less than 2 mm. The second end of the first part may be without any surface areas which form an angle of less than 120° with each other. The second end of the second part may be structured correspondingly.

The second end and/or the flange portion of the first part may comprise a convex surface facing radially outwards and/or facing axially with respect to the first axis. The second end and/or the flange portion of the second part may comprise a convex surface facing radially outwards and/or facing axially with respect to the second axis.

The convex surface, viewed in a cross-section along the longitudinal axis of the current limiting fuse, may show a radius of curvature between 3 mm and 15 mm, preferably between 4 mm and 10 mm, preferably between 5 mm and 8 mm.

The first part may be made of an electrically conductive material, preferably from a metallic material, for example from aluminum, from copper, or from brass. The same applies to the second part.

A wall forming the cylindrical portion of the first part may show a thickness between 1 mm and 5 mm, preferably between 1.5 mm and 4 mm. A wall forming the cylindrical portion of the second part may show a thickness between 1 mm and 5 mm, preferably between 1.5 mm and 4 mm.

The flange portion of the first part may be attached to the cylindrical portion of the first part via a welded connection or plastic deformation. By providing a welded connection, it is possible to ensures that electrical conductivity is achieved over the entire first part.

Correspondingly, the flange portion of the second part may be attached to the cylindrical portion of the second part via a welded connection or plastic deformation.

The first part may further comprise an end wall provided at the first end of the first part on the cylindrical portion. In this way, it can be achieved that the first part as a whole essentially has a cup shape with the end wall forming the base of the cup. Compared to an embodiment in which the first part has no corresponding end wall, the cup shape is principally more effective in terms of electrical shielding.

Correspondingly, the second part may further comprise an end wall provided at the first end of the second part on the cylindrical portion.

The end wall may be attached to the respective cylindrical portion of the first or second part via a welded or glued or mechanical connection and/or via an electrically conductive connection.

The end wall of the first and/or the second part may extend in a plane normal to the longitudinal axis of the current limiting fuse. The end wall of the first and/or the second part is preferably structured in such a way that it extends radially on all sides up to the respective cylindrical portion.

The end wall of the first part may comprise a mounting hole configured to receive a first electrical connection element of the current limiting fuse. The end wall of the second part may comprise a mounting hole configured to receive a second electrical connection element of the current limiting fuse. The first and/or second electrical connection element of the current limiting fuse may comprise a thread, preferably an external thread.

The first part may be held by a coupling between the first electrical connection element of the current limiting fuse and the end wall of the first part, preferably via a nut screwed on an external thread of the electrical connection element. Specifically, the first part may be held to the current limiting fuse only via the coupling. The same applies to a corresponding coupling between the second electrical connection element of the current limiting fuse and the end wall of the second part.

The end wall of the first part and/or the second part may comprise at least one fluid passage opening, preferably at least two fluid passage openings, preferably at least three fluid passage openings.

The cylindrical portion of the first part may comprise at the first end of the first part at least one further fluid passage opening. The cylindrical portion of the second part may comprise at the first end of the second part at least one further fluid passage opening.

The at least one fluid passage opening may be configured for allowing a flow of oil and/or air therethrough.

The at least one fluid passage opening may have a diameter of between 3 mm and 15 mm, preferably of between 4 mm and 10 mm, preferably of between 5 mm and 8 mm.

The current limiting fuse assembly may further comprise a support for supporting the current limiting fuse and/or the shielding arrangement.

The support may be configured to hold the current limiting fuse in an area between the second end of the first part and the second end of the second part.

The support may be made of an electrically non-conducting material, for example of wood and/or plastic.

The support may comprise a plate-like portion having a thickness of between 15 mm and 40 mm, preferably between 20 mm and 30 mm, wherein the plate-like portion holds directly the current limiting fuse.

A first gap may be provided between the support and the second end of the first part and a second gap may be provided between the support and the second end of the second part. The first gap and/or the second gap may be between 0.5 mm and 10 mm, preferably between 0.5 mm and 5 mm.

The support may be also configured to hold at least one further fuse and at least one further shielding arrangement such that the distance between the shielding arrangement and the at least one further shielding arrangement is at least 50 mm, preferably at least 55 mm, preferably at least 60 mm.

The support may comprise a first support part holding both a first electrical connection element of the current limiting fuse and an end wall of the first part, and a second support part holding both a second electrical connection element of the current limiting fuse and an end wall of the second part.

According to the present disclosure, there is also provided a transformer assembly which comprises a core, a winding wound around the core, a tank filled with oil or another dielectric fluid, wherein the core and the winding are positioned at least essentially oil-immersed in the tank, and a current limiting fuse assembly according to the present description, immersed in the oil.

The current limiting fuse assembly may be positioned above the winding.

The winding may be a high-voltage winding.

The transformer assembly may be a pad-mounted transformer assembly.

The rating of the transformer may be between 0.5 MVA and 5 MVA, preferably between 1 MVA and 3 MVA.

According to the present disclosure, there is also provided a shielding arrangement, configured to electrically and mechanically shield a current limiting fuse, particularly to shield a current limiting fuse of a transformer assembly with the current limiting fuse being immersed in oil filled in a tank of the transformer. The shielding arrangement comprises a first part and a second part. The first part may comprise a cylindrical portion extending along a first axis between a first end and a second end, and a flange portion provided at the second end. The second part may comprise a cylindrical portion extending along a second axis between a first end and a second end, and a flange portion provided at the second end. The second part may be configured to be positioned and oriented relative to the first part such that the second end of the second part faces the second end of the first part. The second end of the second part is configured to be arranged at a distance, measured along the first axis, from the second end of the first part.

The first part and the second part of the shieling arrangement may be structured as described above with respect to the current limiting fuse assembly.

In particular, the present disclosure comprises the following aspects:

1. Current limiting fuse assembly, comprising
a current limiting fuse (2) having a longitudinal axis (A), and
a shielding arrangement (4) configured to electrically and mechanically shield the current limiting fuse (2), the shielding arrangement comprising a first part (6) and a second part (8),
the first part (6) comprising a cylindrical portion (60) extending along a first axis (A1) between a first end (62) and a second end (64), and a flange portion (66) provided at the second end (64),
the second part (8) comprising a cylindrical portion (80) extending along a second axis (A2) between a first end (82) and a second end (84), and a flange portion (86) provided at the second end (84),
wherein the second part (8) is positioned and oriented relative to the first part (6) such that the second end (84) of the second part (8) faces the second end (64) of the first part (6), and wherein the second end (84) of the second part (8) is arranged at a distance (L), measured along the longitudinal axis (A), from the second end (64) of the first part (6).

2. The current limiting fuse assembly of aspect 1, wherein the distance (L) is at least 20 mm, preferably at least 25 mm, preferably at least 30 mm, preferably at least 50 mm.

3. The current limiting fuse assembly of aspect 1 or 2, wherein the distance (L) is at maximum 120 mm, preferably at maximum 100 mm, preferably at maximum 80 mm, preferably at maximum 60 mm, preferably at maximum 50 mm, preferably at maximum 40 mm, preferably at maximum 35 mm.

4. The current limiting fuse assembly of any of the preceding aspects, wherein the distance (L) is between 20 mm and 120 mm, preferably between 20 mm and 100 mm, preferably between 25 mm and 80 mm, preferably between 25 mm and 60 mm, preferably between 30 mm and 50 mm, preferably between 30 mm and 40 mm, preferably between 30 mm and 35 mm, for example 33 mm.

5. The current limiting fuse assembly of any of the preceding aspects, wherein the length (L2) of the second part (8) measured along the second axis (A2) is the same as the length (L1) of the first part (6) measured along the first axis (A1).

6. The current limiting fuse assembly of any of the preceding aspects, wherein the length (L2) of the second part (8) measured along the second axis (A2) differs less than 50% from the length (L1) of the first part (6) measured along the first axis (A1), preferably less than 40%, preferably less than 30%, preferably less than 20%, preferably less than 10%.

7. The current limiting fuse assembly of any of the preceding aspects, wherein the second part (8) geometrically generally corresponds to or is identical in construction to the first part (6).

8. The current limiting fuse assembly of any of the preceding aspects, wherein the current limiting fuse (2) partly extends in the cylindrical portion (60) of the first part (6) and partly extends in the cylindrical portion (80) of the second part (8).

9. The current limiting fuse assembly of any of the preceding aspects, wherein the shielding arrangement (4) covers the current limiting fuse (2) over at least 50% of its extent along the longitudinal axis (A), preferably over at least 60%, preferably over at least 70%, preferably over at least 80%.

10. The current limiting fuse assembly of any of the preceding aspects, wherein the first part (6) has a length (L1) measured along the first axis (A1) of between 150 mm and 400 mm, preferably between 200 mm and 300 mm, preferably between 240 mm and 300 mm, and/or wherein the second part (8) has a length (L2) measured along the second axis (A2) of between 150 mm and 400 mm, preferably between 200 mm and 300 mm, preferably between 240 mm and 300 mm.

11. The current limiting fuse assembly of any of the preceding aspects, wherein the first part (6) surrounds a first section (s1) of the current limiting fuse (2), and the second part (8) surrounds a second section (s2) of the current limiting fuse.

12. The current limiting fuse assembly of aspect 11, wherein the length of the second section (s2) of the current limiting fuse (2) is the same as the length of the first section (s1) of the current limiting fuse.

13. The current limiting fuse assembly of aspect 11, wherein the length of the second section (S2) of the current limiting fuse (2) measured along the longitudinal axis (A) differs less than 50% from the length of the first section (S1) of the current limiting fuse (2) measured along the longitudinal axis (A), preferably less than 40%, preferably less than 30%, preferably less than 20%, preferably less than 10%.

14. The current limiting fuse assembly of any of the preceding aspects, wherein the first axis (A1) coincides with the second axis (A2).

15. The current limiting fuse assembly of any of the preceding aspects, wherein the longitudinal axis (A) of the current limiting fuse (2) coincides with at least one of the first axis (A1) and the second axis (A2), preferably wherein the longitudinal axis (A) of the current limiting fuse (2) coincides with both the first axis (A1) and the second axis (A2).

16. The current limiting fuse assembly of any of the preceding aspects, wherein the cylindrical portion (60) of the first part (6) and/or the cylindrical portion (80) of the second part (8) has a circular cross-section.

17. The current limiting fuse assembly of any of aspects 1 to 15, wherein the cylindrical portion (60) of the first part (6) and/or the cylindrical portion (80) of the second part (8) has a non-circular cross-section, for example a rectangular cross-section or a polygonal cross-section, for example a hexagonal cross-section.

18. The current limiting fuse assembly of any of the preceding aspects, wherein, viewed in a cross-section normal to the longitudinal axis (A) of the current limiting fuse (2), an annular gap (g) is formed between the current limiting fuse (2) and the first part (6) and/or between the current limiting fuse (2) and the second part (8).

19. The current limiting fuse assembly of aspect 18, wherein the annular gap is at least 1 mm wide, preferably at least 2 mm, preferably at least 5 mm.

20. The current limiting fuse assembly of any of the preceding aspects, wherein the flange portion (66) of the first part (6) and/or the flange portion (86) of the second part (8) has a closed ring shape.

21. The current limiting fuse assembly of any of the preceding aspects,
wherein the flange portion (66) of the first part (6) shows an outer diameter (D2) which is at least 5% larger than an outer diameter (D1) of the cylindrical portion (60) of the first part (6), preferably at least 10%, preferably at least 15%, and/or
wherein the flange portion (86) of the second part (8) shows an outer diameter which is at least 5% larger than an outer diameter of the cylindrical portion (80) of the second part (8), preferably at least 10%, preferably at least 15%.

22. The current limiting fuse assembly of aspect 21,
wherein the outer diameter (D2) of the flange portion (66) of the first part (6) is at maximum 50% larger than the outer diameter (D1) of the cylindrical portion (60) of the first part (6), preferably at maximum 40% larger, preferably at maximum 30% larger, and/or
wherein the outer diameter of the flange portion (68) of the second part (8) is at maximum 50% larger than the outer diameter of the cylindrical portion (80) of the second part (8), preferably at maximum 40% larger, preferably at maximum 30% larger.

23. The current limiting fuse assembly of aspect 21 or 22,
wherein the outer diameter (D2) of the flange portion (66) of the first part (6) is between 1.05 times and 1.5 times the outer diameter (D1) of the cylindrical portion (60) of the first part (6), preferably between 1.1 times and 1.4 times, preferably between 1.15 times and 1.3 times, and/or
wherein the outer diameter of the flange portion (86) of the second part (8) is between 1.05 times and 1.5 times the outer diameter of the cylindrical portion (80) of the second part (8), preferably between 1.1 times and 1.4 times, preferably between 1.15 times and 1.3 times.

24. The current limiting fuse assembly of any of the preceding aspects, wherein the first part (6) and/or the second part (8) is structured in such a way that the second end (64) of the first part (6) and/or the second end (84) of the second part (8) is without any sharp edges, and/or without any edges having a radius of curvature of less than 5 mm, preferably less than 4 mm, preferably less than 3 mm, preferably less than 2 mm, and/or without any surface areas which form an angle of less than 120° with each other.

25. The current limiting fuse assembly of any of the preceding aspects,
wherein the second end (64) and/or the flange portion (66) of the first part (6), comprises a convex surface (65) facing radially outwards and/or facing axially with respect to the first axis (A1), and/or
wherein the second end (84) and/or the flange portion (86) of the second part (8), comprises a convex surface facing radially outwards and/or facing axially with respect to the second axis.

26. The current limiting fuse assembly of aspect 25, wherein the convex surface (65), viewed in a cross-section along the longitudinal axis (A) of the current limiting fuse (2), shows a radius of curvature between 3 mm and 15 mm, preferably between 4 mm and 10 mm, preferably between 5 mm and 8 mm.

27. The current limiting fuse assembly of any of the preceding aspects, wherein the first part (6) and/or the second part (8) is made of an electrically conductive material, preferably from a metallic material, for example from aluminum, from copper, or from brass.

28. The current limiting fuse assembly of any of the preceding aspects,
wherein a wall forming the cylindrical portion (60) of the first part (6) shows a thickness between 1 mm and 5 mm, preferably between 1.5 mm and 4 mm, and/or
wherein a wall forming the cylindrical portion (80) of the second part (8) shows a thickness between 1 mm and 5 mm, preferably between 1.5 mm and 4 mm.

29. The current limiting fuse assembly of any of the preceding aspects,
wherein the flange portion (66) of the first part (6) is attached to the cylindrical portion (60) of the first part (6) via a welded connection or plastic deformation, and/or
wherein the flange portion (86) of the second part (8) is attached to the cylindrical portion (80) of the second part (8) via a welded connection or plastic deformation.

30. The current limiting fuse assembly of any of the preceding aspects,
wherein the first part (6) further comprises an end wall (61) provided at the first end (62) of the first part (6) on the cylindrical portion (60), and/or
wherein the second part (8) further comprises an end wall provided at the first end (82) of the second part (8) on the cylindrical portion (80).

31. The current limiting fuse assembly of aspect 30,
wherein the end wall (61) is attached to the respective cylindrical portion (60, 80) of the first or second part (6, 8) via a welded or glued or mechanical connection and/or via an electrically conductive connection.

32. The current limiting fuse assembly of aspect 30 or 31,
wherein the end wall (61) of the first part (6) comprises a mounting hole (611) configured to receive a first electrical connection element (22) of the current limiting fuse (2), and/or
wherein the end wall of the second part (8) comprises a mounting hole configured to receive a second electrical connection element (24) of the current limiting fuse (2).

33. The current limiting fuse assembly of aspect 32, wherein the first and/or second electrical connection element (22, 24) comprises a thread, preferably an external thread.

34. The current limiting fuse assembly of aspect 32 or 33,
wherein the first part (6) is held by a coupling between the first electrical connection element (22) of the current limiting fuse (2) and the end wall (61) of the first part (6), preferably via a nut (23) screwed on an external thread of the electrical connection element (22), and/or
   wherein the second part (8) is held by a coupling between the second electrical connection element (24) of the current limiting fuse (2) and the end wall of the second part (8), preferably via a nut screwed on an external thread of the electrical connection element (24).

35. The current limiting fuse assembly of any of aspects 32 to 35, wherein the end wall (61) of the first part (6) and/or the second part (8) comprises at least one fluid passage opening (69), preferably at least two fluid passage openings, preferably at least three fluid passage openings.

36. The current limiting fuse assembly of any of the preceding aspects,
wherein the cylindrical portion (60) of the first part (6) comprises at the first end (62) of the first part (6) at least one further fluid passage opening (67), and/or
wherein the cylindrical portion (80) of the second part (8) comprises at the first end (82) of the second part (8) at least one further fluid passage opening.

37. The current limiting fuse assembly of aspect 35 or 36, wherein the at least one fluid passage opening (69, 67) is configured for allowing a flow of oil (107) and/or air therethrough.

38. The current limiting fuse assembly of any of aspects 35 to 37, wherein the at least one fluid passage opening (69, 67) has a diameter of between 3 mm and 15 mm, preferably of between 4 mm and 10 mm, preferably of between 5 mm and 8 mm.

39. The current limiting fuse assembly of any of the preceding aspects, further comprising a support (3, 32, 34) for supporting the current limiting fuse (2) and/or the shielding arrangement (4).

40. The current limiting fuse assembly of aspect 39, wherein the support (3) holds the current limiting fuse (2) in an area between the second end (64) of the first part (6) and the second end (84) of the second part (8).

41. The current limiting fuse assembly of aspect 39 or 40, wherein the support (3) is made of an electrically non-conducting material, for example of wood and/or plastic.

42. The current limiting fuse assembly of any of aspects 39 to 41, wherein the support (3) comprises a plate-like portion having a thickness of between 15 mm and 40 mm, preferably between 20 mm and 30 mm, wherein the plate-like portion holds directly the current limiting fuse (2).

43. The current limiting fuse assembly of any aspects 39 to 42, wherein a first gap is provided between the support (3) and the second end (64) of the first part (6) and a second gap is provided between the support (3) and the second end (84) of the second part (8).

44. The current limiting fuse assembly of any of aspects 39 to 43, wherein the support (4) is also configured to hold at least one further fuse and at least one further shielding arrangement (4′) such that the distance (A) between the shielding arrangement (4) and the at least one further shielding arrangement (4′) is at least 50 mm, preferably at least 55 mm, preferably at least 60 mm.

45. The current limiting fuse assembly of aspect 39, wherein the support (32, 34) comprises a first support part (32) holding both a first electrical connection element (22) of the current limiting fuse (2) and an end wall (61) of the first part (6), and a second support part (34) holding both a second electrical connection element (24) of the current limiting fuse (2) and an end wall of the second part (8).

46. Transformer assembly, comprising
a core (102),
a winding (104) wound around the core,
a tank (106) filled with oil (107), wherein the core and the winding are positioned at least essentially oil-immersed in the tank, and
a current limiting fuse assembly according to any of aspects 1 to 45, immersed in the oil.

44. The transformer assembly of aspect 43, wherein the current limiting fuse assembly is positioned above the winding (104).

45. The transformer assembly of aspect 43 or 44, wherein the winding (104) is a high-voltage winding.

46. The transformer assembly of any of aspects 43 to 45, wherein the transformer assembly is a pad-mounted transformer assembly.

47. The transformer assembly of any of aspects 43 to 46, wherein the rating of the transformer is between 0.5 MVA and 10 MVA, preferably between 1 MVA and 5 MVA.

48. Shielding arrangement (4), configured to electrically and mechanically shield a current limiting fuse (2), particularly to shield a current limiting fuse (2) of a transformer assembly with the current limiting fuse being immersed in oil (107) filled in a tank (106) of the transformer, the shielding arrangement comprising a first part (6) and a second part (8),
the first part (6) comprising a cylindrical portion (60) extending along a first axis (A1) between a first end (62) and a second end (64), and a flange portion (66) provided at the second end (64),
the second part (8) comprising a cylindrical portion (80) extending along a second axis (A2) between a first end (82) and a second end (84), and a flange portion (86) provided at the second end (84),
wherein the second part (8) is configured to be positioned and oriented relative to the first part (6) such that the second end (84) of the second part (8) faces the second end (64) of the first part (6), and wherein the second end (84) of the second part (8) is arranged at a distance (L), measured along the first axis (A1), from the second end (64) of the first part (6).

### SHORT DESCRIPTION OF THE DRAWINGS

The subject-matter of the disclosure will be explained in more detail with reference to preferred exemplary embodiments which are illustrated in the attached drawings.

FIG. 1a is a schematic cross-section of a transformer assembly which comprises a transformer and current limiting fuses arranged above an active part of the transformer.

FIG. 1b is a schematic perspective view of the transformer and the current limiting fuses of FIG. 1a.

FIG. 2 is a perspective view of a current limiting fuse assembly comprising a first part and a second part.

FIG. 3a is a schematic side view of the current limiting fuse assembly.

FIG. 3b is a corresponding schematic cross-section showing the relative positions of the current limiting fuse and the two parts of the shielding arrangement.

FIG. 4a is a schematic perspective view of a first part of a shielding arrangement of a current limiting fuse assembly.

FIG. 4b is a schematic perspective view of a shielding arrangement, comprising a first part and a second part.

FIG. 5 is a schematic cross-section of the first part of a current limiting fuse assembly.

FIG. 6 is a perspective view of a first end of a first part of a current limiting fuse assembly.

FIG. 7a is a perspective view of three current limiting fuses arranged in a tank of a transformer assembly.

FIG. 7b is a corresponding perspective view, showing each of the current limiting fuses provided with a shielding arrangement.

FIG. 8 is a schematic perspective view of a support which is configured to hold three current limiting fuses.

FIG. 9 is a schematic perspective view of an alternative support, comprising two support parts.

### DETAILED DESCRIPTION

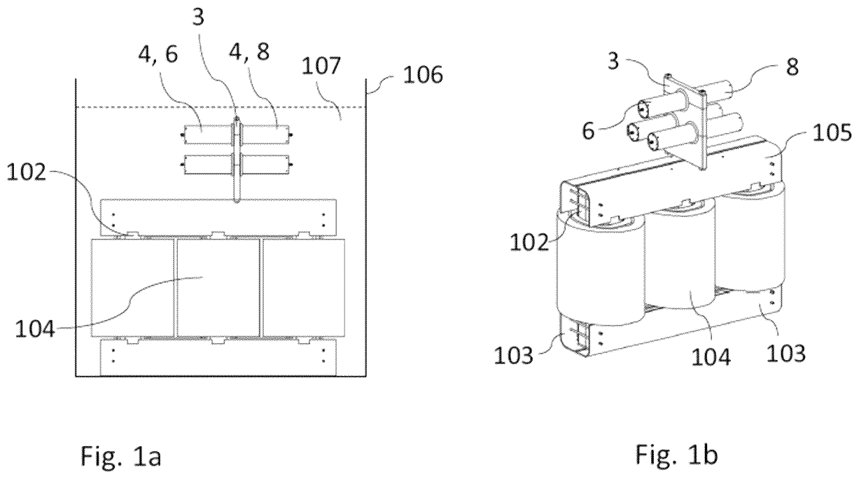

FIG. 1a is a schematic cross-section of a transformer assembly according to the present disclosure. The transformer assembly comprises a transformer having a core 102 and a winding 104 wound around the core 102. The transformer assembly further comprises a tank 106 which is filled with oil 107 or another dielectric fluid. The core 102 and the winding 104 are positioned at least essentially oil- or fluid-immersed in the tank 106.

The transformer assembly further comprises at least one current limiting fuse assembly according to the present disclosure immersed in the oil 107 or the dielectric fluid.

FIG. 1b is a schematic perspective view of the transformer having the core 102 and the winding 104 and the current limiting fuse assembly. In the illustrated example, the transformer assembly comprises three current limiting fuses, each part of a corresponding current limiting fuse assembly. However, in principle, any number of current limiting fuses can be provided. The current limiting fuses can all be constructed in the same or in a corresponding way.

The transformer assembly may have further parts as known as such for transformers, for example clamping plates 103 for clamping a bottom yoke of the core 102, clamping plates 105 for clamping a top yoke of the core 102, further fuses such as Bay-O-Net fuses, bushings, and so on.

The current limiting fuses are arranged above the winding 104, particularly above a high voltage winding 104. The transformer assembly may be a pad-mounted transformer assembly. The rating of the transformer may be between 1 MVA and 5 MVA.

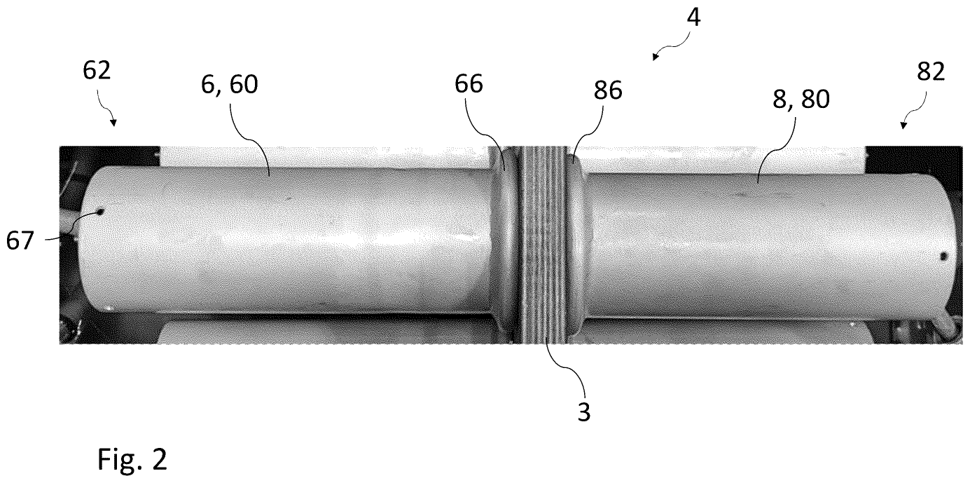

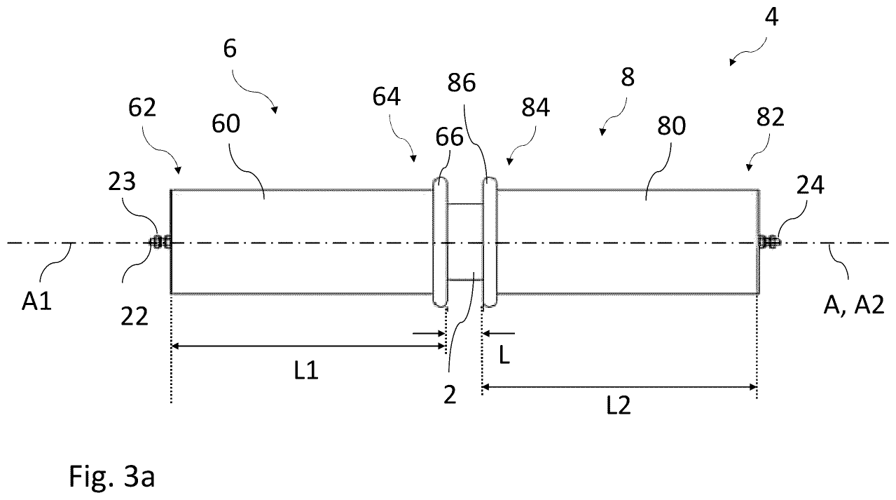

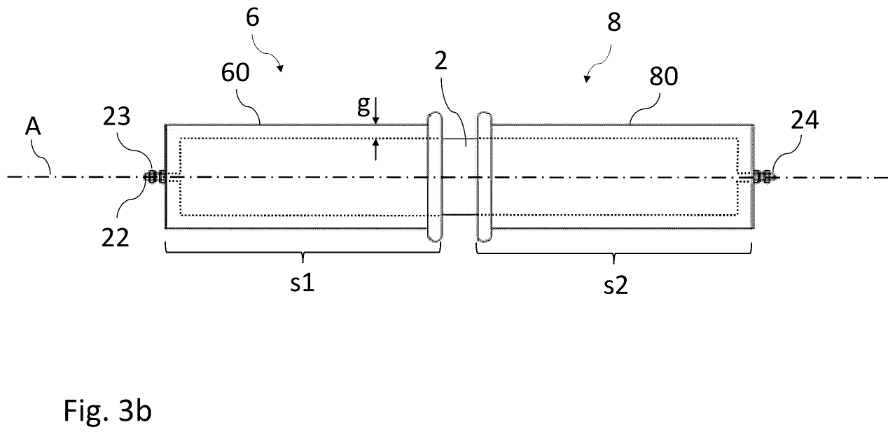

FIG. 2 is a perspective view of a current limiting fuse assembly according to the present disclosure. FIG. 3a is a corresponding schematic cross-section of a current limiting fuse assembly. The current limiting fuse assembly comprises a current limiting fuse 2 having a longitudinal axis A and a shielding arrangement 4 which is configured to electrically and mechanically shield the current limiting fuse 2, particularly such that the current limiting fuse 2 does not interfere in an undesirable manner with a partial discharge test conducted with the transformer assembly. The shielding arrangement 4 is further configured to mechanically shield the current limiting fuse 2 in the event of an explosion of the fuse body.

The shielding arrangement 4 comprises a first part 6 and a second part 8. The first part 6 comprises a cylindrical portion 60 which extends along a first axis A1. In the illustrated example, the first axis A1 coincides with the longitudinal axis A of the current limiting fuse 2. The cylindrical portion 60 of the first part 6 extends along the first axis A1 between a first end 62 and a second end 64. The second part 8 comprises a cylindrical portion 80 which extends along a second axis A2. In the illustrated example, the second axis A2 coincides with the longitudinal axis A of the current limiting fuse 2. The cylindrical portion 80 of the second part 8 extends long the second axis A2 between a first end 82 and a second end 84.

The first part 6 further comprises a flange portion 66 provided at the second end 64. The configuration is such that the flange portion 66 constitutes the second end 64. In other words, at the second end 64 of the first part 6, the cylindrical portion 60 does not extend beyond the flange portion 66 in a direction of the first axis A1. The second part 8 further comprises an analogue flange portion 86.

The second part 8 is positioned and oriented relative to the first part 6 such that the second end 84 of the second part 8 faces the second end 64 of the first part 6. In other words, the flange portions 66 and 86 of the two parts 6, 8 face each other.

The second end 84 of the second part 8 is arranged at a distance L measured along the longitudinal axis A from the second end 64 of the first part 6. The distance L is to avoid spark formation if an electrical voltage is applied to the current limiting fuse 2.

The current limiting fuse 2 may for example be a fuse of class 38 kV. The distance L may be for example between 30 and 40 mm.

In the illustrated example, the length L2 of the second part 8 measured along the longitudinal axis A is the same as the length L1 of the first part 6. It is generally advantageous if the two lengths L1, L2 do not differ by more than 50%. The first length L1 may be for example between 200 mm and 300 mm. The same applies to the second length L2.

As exemplarily shown in FIG. 3b, the current limiting fuse 2 extends with a first section s1 in the first part 6 and with a second section s2 in the second part 8. In other words, the first part 6 surrounds the first section s1 and the second part 8 surrounds the second section s2 of the current limiting fuse 2. Preferably, the two parts 6, 8 or the shielding arrangement 4 surround or cover the current limiting fuse 2 over at least 70% of its length measured along the longitudinal axis A.

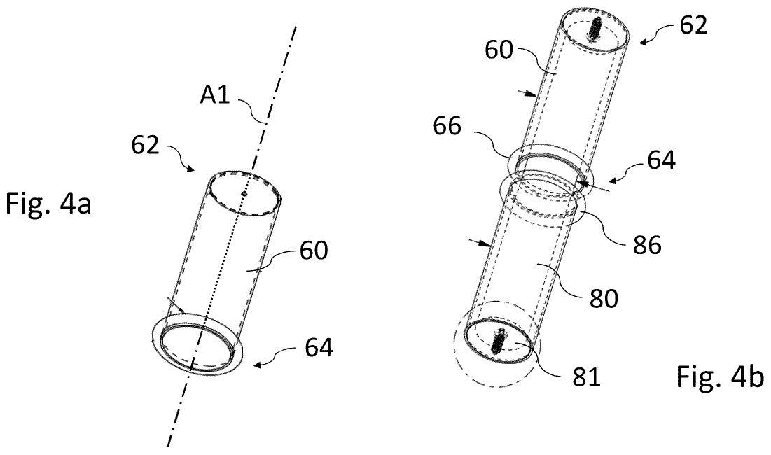

FIG. 4a is a schematic perspective view of the first part 6 of the current limiting fuse assembly. FIG. 4b is a schematic perspective view of the shielding arrangement 4, comprising the first part 6 and the second part 8. In the illustrated example, the cylindrical portion 60 of the first part 6 has a circular cross-section, as viewed in a plane normal to the longitudinal axis A. An annular gap g (see FIG. 3b) is formed between the current limiting fuse 2 and the first part 6, particularly between an outer surface of the current limiting fuse 2 and an inner surface of the cylindrical portion 60 of the first part 6. The same applies to the cylindrical portion 80 of the second part 8. The width of the annular gap g is preferably less than the distance L between the two parts 6, 8. The annular gap g may be for example between 5 mm and 10 mm.

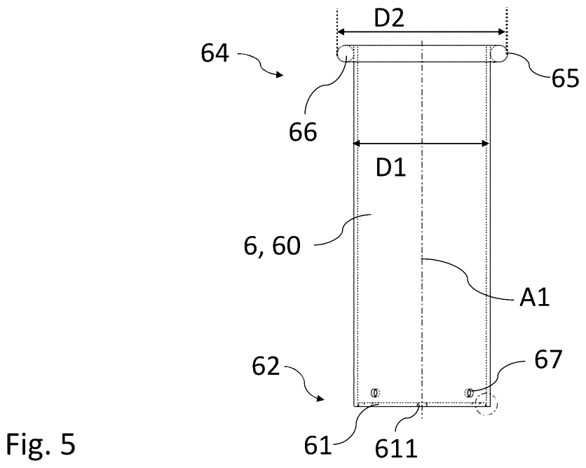

FIG. 5 is a schematic cross-section of the first part 6. The outer diameter D2 of the flange portion 60 is larger than the outer diameter D1 of the cylindrical portion 60. For example, D2 may between 10% and 40% larger than D1.

The second end 64 of the first part 6, especially its flange portion 66 is structured such that does not have any sharp edges. This is to prevent formation of sparks. To this end, the second end 64 is shaped such that it does not have any edges having a radius of curvature which is less than 3 mm. In the illustrated example, the second end 64 comprises a convex surface 65 which faces radially outwards. Preferably, the convex surface 65 extends—with respect to the longitudinal axis A—circumferentially in a closed ring-shaped manner. The same applies to the second end 84 of the second part 8.

The first part 6 and the second part 8 are made from an electrically conductive material such as for example aluminum or copper. The thickness of the walls forming the cylindrical portions 60, 80 may be for example between 1 mm and 5 mm. The flange portions 66, 86 are welded to the respective cylindrical portions 60, 80. In this way, suitable electrical conductivity of the parts 6, 8 can be achieved.

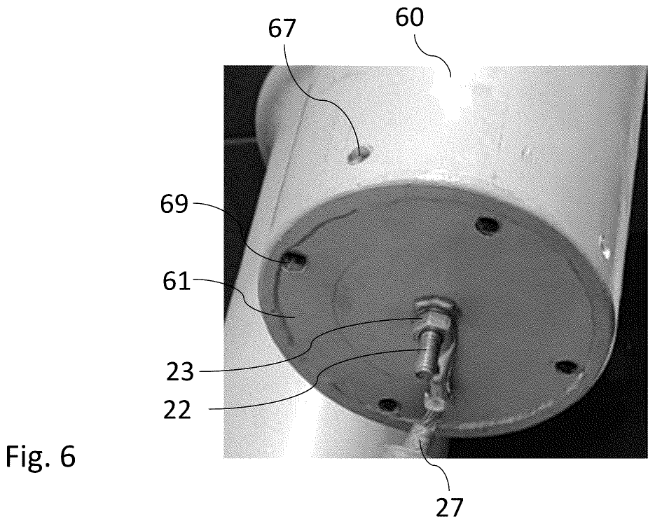

The first part 6 further comprises an end wall 61 provided at the first end 62 on the cylindrical portion 60. FIG. 6 is a perspective view of the first end 62 of the first part 6 showing the end wall 61. The end wall 61 is welded to the cylindrical portion 60 to achieve electrical conductivity. The end wall 62 has a mounting hole 611 (FIG. 5) configured to receive a first electrical connection element 22 (FIGS. 3b, 6) of the current limiting fuse 2. The second part 8 comprises a corresponding end wall having a mounting hole configured to receive a second electrical connection element 24 of the current limiting fuse 2. The first electrical connection element 22 may have an external thread. The first part 6 may be held by a coupling between the first electrical connection element 22 of the current limiting fuse 2 and the end wall 61 of the first part 6, for example via a nut 23. Again, the same applies to the second end wall and the second electrical connection element 24. The configuration may be such that the shielding arrangement 4 is secured to the current limiting fuse 2 exclusively via these two couplings between the end walls and the electrical connection elements 22, 24. FIG. 6 further shows a connection cable 27 electrically connected to the first electrical connection element 22.

The end wall 61 of the first part 6 preferably comprises at least one fluid passage opening 69 (FIG. 6), for example four fluid passage openings 69. Further fluid passage openings 67 may be provided in the cylindrical portion 60, preferably at the first end 62. Corresponding fluid passage openings may be provided in the end wall and the cylindrical portion 80 of the second part 8. The fluid passage openings 67, 69 are configured for allowing a flow of the oil or the other dielectric fluid and may have a diameter of between 5 mm and 10 mm.

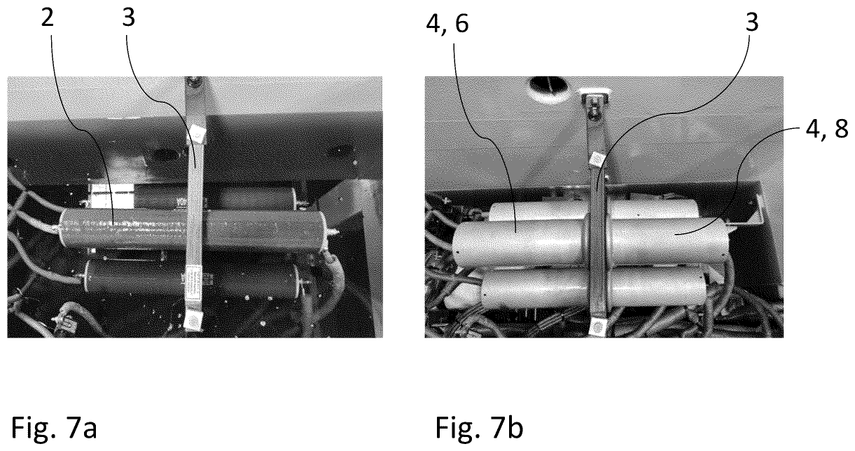

FIG. 7a is a perspective view of three current limiting fuses arranged in a tank of a transformer assembly. FIG. 7b is a corresponding perspective view, showing each of the current limiting fuses provided with a corresponding shielding arrangement 4 according to the present disclosure.

The current limiting fuse assembly may further comprise a support 3 for supporting the current limiting fuse 2 and/or the shielding arrangement 4. As shown for example in FIGS. 1b, 2, and 7b, the support 3 holds the current limiting fuse 2 in an area between the second end 64 of the first part 6 and the second end 84 of the second part 8. In other words, the support 3 holds the current limiting fuse 2 between the two flange portions 66 and 86. The support 3 is made of an electrically non-conductive material, for example of wood and/or plastic.

In the illustrated example, the support 3 comprises a plate-like portion having a thickness which at maximum equals the distance L between the flange portions 66 and 86. Preferably, a first gap is provided between the support 3 and the second end 64 of the first part 6 and a second gap is provided between the support 3 and the second end 84 of the second part 8. The first gap may be between 1 mm and 3 mm wide, for example. The same holds for the second gap.

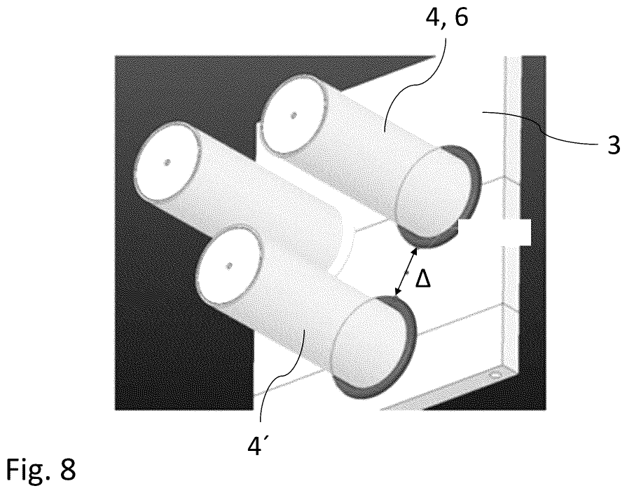

As illustrated for example in FIGS. 1b and 8, the support 3 may be further configured to hold several corresponding current limiting fuses, each with a respective shielding arrangement 4, 4′. In this case, the distance A between two neighbouring shielding arrangements 4, 4′ is preferably at least 50 mm.

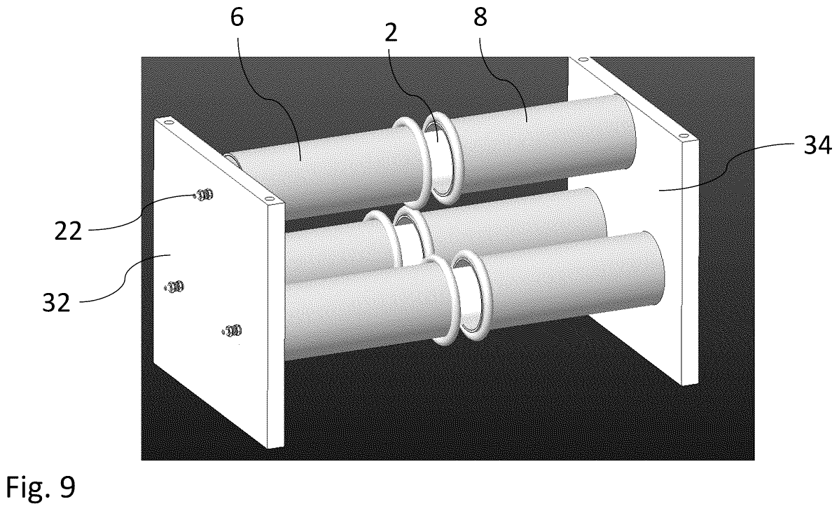

FIG. 9 shows an alternative support 32, 34 which may comprise a first support part 32 holding both a first electrical connection element 22 of the current limiting fuse 2 and an end wall 61 of the first part 6, and a second support part 34 holding both, a second electrical connection element 24 of the current limiting fuse 2 and an end wall of the second part 8. In this configuration, the support 32, 34 may also be configured to hold several corresponding current limiting fuses, for example three fuses, as exemplarily illustrated in FIG. 9. While the present disclosure has been described in detail in the drawings and forgoing description, such description is to be considered illustrative or exemplary and not restrictive. Variations to the disclosed embodiments can be understood and effected by those skilled in the art and practicing the claimed subject-matter, from a study of the drawings, the disclosure, and the appended claims. In the claims, the word “comprising” does not exclude other elements, and the indefinite article “a” or “an” does not exclude a plurality. The mere fact that certain elements or steps are recited in distinct claims does not indicate that a combination of these elements or steps cannot be used to advantage, specifically, in addition to the actual claim dependency, any further meaningful claim combination shall be considered disclosed.

1. A current limiting fuse assembly, comprising
a current limiting fuse having a longitudinal axis, and
a shielding arrangement configured to electrically and mechanically shield the current limiting fuse, the shielding arrangement comprising a first part and a second part,
the first part comprising a cylindrical portion extending along a first axis between a first end and a second end, and a flange portion provided at the second end,
the second part comprising a cylindrical portion extending along a second axis between a first end and a second end, and a flange portion provided at the second end),
wherein the second part is positioned and oriented relative to the first part such that the second end of the second part faces the second end of the first part, and wherein the second end of the second part is arranged at a distance, measured along the longitudinal axis, from the second end of the first part.

2. The current limiting fuse assembly of claim 1, wherein the distance is between 20 mm and 120 mm, between 20 mm and 100 mm, between 25 mm and 80 mm, between 25 mm and 60 mm, between 30 mm and 50 mm, between 30 mm and 40 mm, or between 30 mm and 35 mm.

3. The current limiting fuse assembly of claim 1, wherein the length of the second part measured along the second axis differs less than 50% from the length of the first part measured along the first axis, less than 40%, less than 30%, less than 20%, or less than 10%.

4. The current limiting fuse assembly of claim 1, wherein the second part geometrically generally corresponds to or is identical in construction to the first part.

5. The current limiting fuse assembly of claim 1,
wherein the first part has a length measured along the first axis of between 150 mm and 400 mm, between 200 mm and 300 mm, or between 240 mm and 300 mm, and/or
wherein the second part has a length measured along the second axis of between 150 mm and 400 mm, between 200 mm and 300 mm, or between 240 mm and 300 mm.

6. The current limiting fuse assembly of claim 1,
wherein the flange portion of the first part shows an outer diameter which is at least 5% larger than an outer diameter of the cylindrical portion of the first part, at least 10%, or at least 15%, and/or
wherein the flange portion of the second part shows an outer diameter which is at least 5% larger than an outer diameter of the cylindrical portion of the second part, at least 10%, or at least 15%.

7. The current limiting fuse assembly of claim 1, wherein the first part or the second part is structured in such a way that the second end of the first part and/or the second end of the second part is without any sharp edges, and/or without any edges having a radius of curvature of less than 5 mm, and/or without any surface areas which form an angle of less than 120° with each other.

8. The current limiting fuse assembly of claim 1, wherein the first part and/or the second part is made of an electrically conductive material, and/or
wherein a wall forming the cylindrical portion of the first part shows a thickness between 1 mm and 5 mm, and/or
wherein a wall forming the cylindrical portion of the second part shows a thickness between 1 mm and 5 mm.

9. The current limiting fuse assembly of claim 1,
wherein the first part further comprises an end wall provided at the first end of the first part on the cylindrical portion, and/or
wherein the second part further comprises an end wall provided at the first end of the second part on the cylindrical portion,
wherein the end wall of the first part and/or the end wall of the second part comprises a mounting hole configured to receive an electrical connection element of the current limiting fuse.

10. The current limiting fuse assembly of claim 1, further comprising a support for supporting the current limiting fuse and/or the shielding arrangement.

11. The current limiting fuse assembly of claim 10, wherein a first gap is provided between the support and the second end of the first part and a second gap is provided between the support and the second end of the second part.

12. The current limiting fuse assembly of claim 10, wherein the support is also configured to hold at least one further fuse and at least one further shielding arrangement such that the distance between the shielding arrangement and the at least one further shielding arrangement is at least 50 mm, at least 55 mm, or at least 60 mm.

13. The current limiting fuse assembly of claim 10, wherein the support comprises a first support part holding both a first electrical connection element of the current limiting fuse and an end wall of the first part, and a second support part holding both a second electrical connection element of the current limiting fuse and an end wall of the second part.

14. A transformer assembly, comprising
a core,
a winding wound around the core,
a tank filled with oil, wherein the core and the winding are positioned at least essentially oil-immersed in the tank, and
a current limiting fuse assembly according to claim 1, immersed in the oil.

15. A shielding arrangement, configured to electrically and mechanically shield a current limiting fuse, particularly to shield a current limiting fuse of a transformer assembly with the current limiting fuse being immersed in oil filled in a tank of the transformer, the shielding arrangement comprising a first part and a second part,
the first part comprising a cylindrical portion extending along a first axis between a first end and a second end, and a flange portion provided at the second end,
the second part comprising a cylindrical portion extending along a second axis between a first end and a second end, and a flange portion provided at the second end,
wherein the second part is configured to be positioned and oriented relative to the first part such that the second end of the second part faces the second end of the first part, and wherein the second end of the second part is arranged at a distance, measured along the first axis, from the second end of the first part.
